(19) United States
(12) Patent Application Publication
(10) Pub. No.: US 2017/0261239 A1
(43) Pub. Date: Sep. 14, 2017

(54) CRYOSTAT WITH CRYOGENIC REFRIGERATOR

(71) Applicant: Siemens Healthcare Limited, Camberley (GB)

(72) Inventor: Neil Charles Tigwell, Witney (GB)

(73) Assignee: Siemens Healthcare Limited, Camberley (GB)

(21) Appl. No.: 15/454,205

(22) Filed: Mar. 9, 2017

(30) Foreign Application Priority Data
Mar. 11, 2016 (GB) 1604233.5

(51) Int. Cl. F25B 19/00; F25B 49/00; H01F 6/04; F25B 41/04

(52) U.S. Cl. CPC F25B 19/005; F25B 41/04; F25B 49/005; H01F 6/04; F25B 2500/11

(57) ABSTRACT

A cryostat includes a cryogenic refrigerator arranged to cool the interior of a cryogen vessel within the cryostat, the cryogenic refrigerator being arranged inside a refrigerator sock. A pipe is controlled by a passive temperature-sensitive valve to selectively provide a path for cryogen gas flow through the refrigerator sock. The passive temperature-sensitive valve is controlled according to a temperature of the cryogen gas supplied from the refrigerator sock to the passive temperature-sensitive valve.

### BACKGROUND OF THE INVENTION

Field of the Invention

The present invention relates to valve arrangements for control of flow of cryogen gas in a cryostat, particularly a cryostat containing a superconducting magnet, and more particularly a cryostat containing a superconducting magnet of an MRI system.

Description of the Prior Art

FIG. 1 shows a conventional arrangement of a cryostat including a cryogen vessel 12. A cooled superconducting magnet 10 is provided within cryogen vessel 12, itself retained within an outer vacuum chamber (OVC) 14. One or more thermal radiation shields 16 are provided in the vacuum space between the cryogen vessel 12 and the outer vacuum chamber 14. In some known arrangements, a refrigerator 17 is mounted in a refrigerator sock 15 located in a turret 18 provided for the purpose, toward the side of the cryostat. Alternatively, a refrigerator 17 may be located within access turret 19, which retains access neck (vent pipe) 20 mounted at the top of the cryostat. The refrigerator 17 provides active refrigeration to cool cryogen gas within the cryogen vessel 12, in some arrangements by recondensing it into a liquid. The refrigerator 17 may also serve to cool the radiation shield 16. As illustrated in FIG. 1, the refrigerator 17 may be a two-stage refrigerator. A first cooling stage is thermally linked to the radiation shield 16, and provides cooling to a first temperature, typically in the region of 80-100K. A second cooling stage provides cooling of the cryogen gas to a much lower temperature, typically in the region of 4-10K.

A negative electrical connection 21a is usually provided to the magnet 10 through the body of the cryostat. A positive electrical connection 21 is usually provided by a conductor passing through the vent pipe 20.

For some time it has been recognized that allowing a circulation of gas between the magnet turret through vent pipe 20 and refrigerator sock 15 increases the efficiency of the refrigerator 17. Pipe 22 in FIG. 1 is an example of an arrangement allowing such circulation. Valve 23 may be controlled to enable or restrict such circulation as required.

The efficiency of the refrigerator 17 may be measured by the amount of power a heater requires to maintain a constant gas pressure in the cryogen vessel. In order to gain an efficiency increase the valve 23 which connects the refrigerator sock 15 with an absolute pressure relief valve 25, which allows cryogen to vent through a quench line 27 in case of excessive pressure within the cryogen vessel. Valve 23 is left open while the magnet is in operation as a part of an MRI system, keeping a cryogen gas flow path open between refrigerator sock 15 and turret 20. Absolute pressure relief valve 25 will open to allow cryogen to leave the cryogen vessel through quench path 27 in case of quench, or in case the cryogen pressure in the cryogen vessel reaches a high level for any other reason.

The function of the valve 23 is to allow cold gas to pass through the refrigerator sock 15 during shipping, to cool the refrigerator 17 and so to limit heat input through the refrigerator to the radiation shield.

It is desirable to leave the valve 23 open after shipping to enable the refrigerator 17 to be cooled in the event of a refrigerator, compressor or power failure. However if the valve 23 is left open there is a possibility of too much cooling of the refrigerator 17 during filling of the cryogen vessel, quenching of the magnet or during energization of the magnet.

Over-cooling of the refrigerator can cause failure modes, for example due to rubber o-rings installed in the refrigerator becoming hard and leaking. A rubber o-ring sealing the refrigerator 17 to the refrigerator sock could leak.

Conventionally, this problem has been avoided by closing the valve 23 during normal operation, and the benefits of increased efficiency of the refrigerator 17 due to circulation of gas between the magnet turret through vent pipe 20 and refrigerator sock 15 are not available.

### SUMMARY OF THE INVENTION

The present invention provides an arrangement for selectively enabling and blocking flow of cryogen gas through the refrigerator sock 15.

### BRIEF DESCRIPTION OF THE DRAWINGS

FIG. 1 shows a conventional arrangement of a cryostat including a cryogen vessel.

FIG. 2 shows an example refrigerator and venting arrangement, according to an embodiment of the present invention.

FIGS. 3A-3B represent a valve using a bi-metallic ‘snap disc’ commonly used in thermostats.

FIGS. 4A and 4B illustrate components of a prototype valve in operation.

### DESCRIPTION OF THE PREFERRED EMBODIMENTS

According to the present invention, a passive temperature-sensitive valve is introduced, whereby flow of cryogen gas through the refrigerator sock 15 may be controlled.

The passive temperature-sensitive valve is reactive to a combination of the cryogen temperature and of the temperature of the body of the valve. In the described example, the temperature of the body of the valve is determined by a combination of the temperature of the cryogen gas supplied from the refrigerator sock to the temperature-sensitive valve; ambient temperature; and the temperature of equipment to which the valve is mounted.

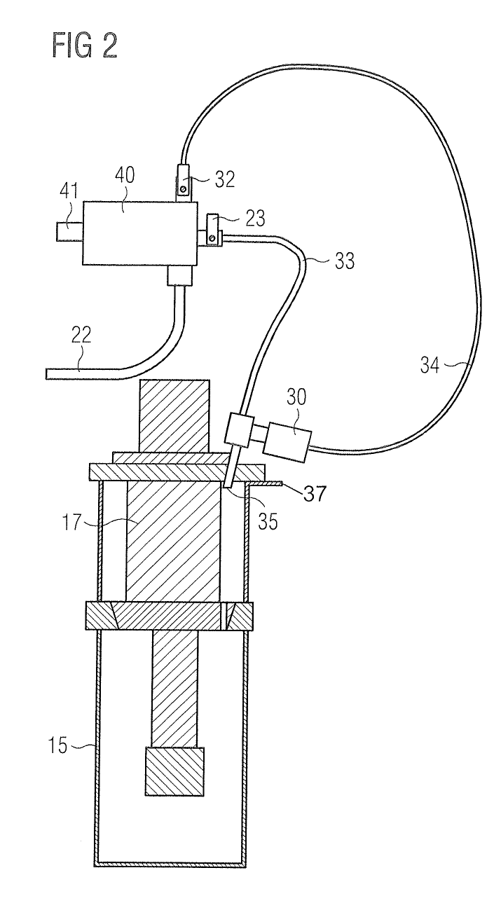

FIG. 2 shows a refrigerator and venting arrangement, according to an embodiment of the present invention. An additional, passive temperature-sensitive, valve 30 is provided, in series with an enabling valve 32. This arrangement is effectively connected in parallel to the conventional valve 23 described above.

During transit, the conventional valve 23 is opened, allowing a flow of cooling gas through the flow path in pipe 22 and past the refrigerator 17 to reduce heat influx by conduction. According to the illustrated embodiment, a further pipe 34 is added, providing a parallel path, bypassing valve 23, the pipe 34 allowing a flow of cryogen gas past the refrigerator 17 as controlled by the series combination of passive temperature-sensitive valve 30 and enabling valve 32, even while valve 23 is closed.

Cryogen gas flow paths 33, 34 meet. The two paths may meet at the inlet manifold of the vent valve 40, for convenience sake.

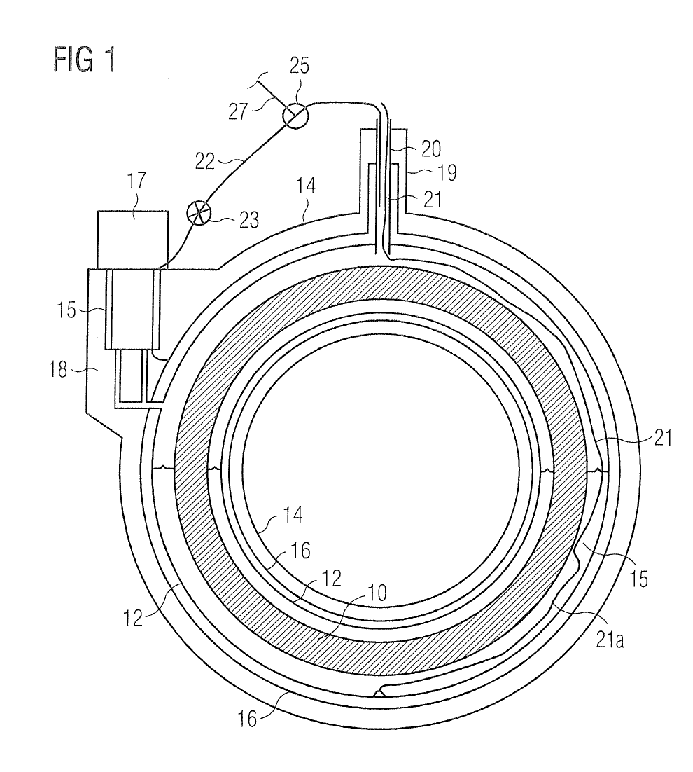

This enables circulation of the cryogen gas back into the cryostat turret through pipe 22, while providing an egress path 41, similar to quench path 25 of FIG. 1, for cryogen gas in case of pressure build-up within the cryogen vessel such as during shipment or power failure.

The passive temperature-sensitive valve 30 is preferably not relied upon to enable cryogen gas egress during transit, as the ambient temperature could fall sufficiently that the temperature sensitive valve closes. Rather, the conventional valve 23 is opened to ensure that an egress path is available for cryogen gas to exit the cryogen vessel and to cool the refrigerator as it passes.

After arrival on site, the conventional valve 23 is closed and the enabling valve 32 is opened, allowing bypass cryogen gas path 34 to be controlled by the temperature sensitive valve 30. A two way valve could be used instead, combining the functions of the conventional valve 23 and the enabling valve 32, so that only one or other of these valves may be open at any one time.

In an example embodiment, the passive temperature-sensitive valve 30 closes when its temperature decreases to about 0° C., and opens when its temperature rises to about 15° C. In the present invention, the passive temperature-sensitive valve does not seek to regulate the temperature of the gas flowing through it, but rather the passive temperature-sensitive valve reacts to its own temperature, the temperature of the gas supplied to the valve, the temperature of the body of the passive temperature-sensitive valve as determined by a combination of the temperature of any gas flowing through it, ambient temperature and the temperature of any equipment to which the valve is mounted. In the illustrated embodiment, the passive temperature-sensitive valve 30 is mounted to a mounting flange 37 of the refrigerator 17. Thermal conduction will mean that the temperature of the passive temperature-sensitive valve 30 is at least partially determined by the temperature of the mounting flange 37 of the refrigerator 17.

The temperature sensitive valve 30 would operate to stop gas flow through the refrigerator sock 15 in the event of significant mass of cryogen being vented from the cryogen vessel, such as may occur during a cryogen fill procedure, or during a quench, as it would be cooled below the temperature required for its transition to a “closed” state. By closing, the passive temperature-sensitive valve 30 protects the refrigerator 17 from being overcooled.

In the example embodiment illustrated, the passive temperature-sensitive valve 30 is shown connected to a conventional gas outlet 35 at a mounting flange 37 of the refrigerator 17. In systems studied as background for the cryostat described herein, it was found that, during cryogen filling, quenching and current ramping, vent valve 40 may open, allowing venting 41 of cryogen gas. The area of the mounting flange 37 at the gas outlet 35 becomes coated in a frost of water ice on external surfaces if cryogen gas is allowed to egress due to the elevated cryogen pressure within the cryogen vessel. In such circumstances, the present invention requires that the passive temperature-sensitive valve 30 should close and shut off cryogen gas flow past the refrigerator 17.

In the event of refrigerator 17 failure, the pressure within the cryogen vessel will rise, and open the vent valve 40 to vent cryogen gas from the system. This indicates a lower flow rate and reduced cooling effect of cryogen egress through the refrigerator sock 15 as compared to the above examples of cryogen egress during cryogen filling, quenching and current ramping. In the aforementioned systems that were studied, the area around the mounting flange shows condensed liquid water but not frozen water on the external surfaces. Therefore, in certain embodiments of the invention, the valve is arranged to close at about 0° C. to achieve the desired result of closing in case of cryogen filling, quenching and current ramping but remaining open in case of refrigerator failure. In alternative embodiments, the temperature sensitive valve 30 may be moved further from the refrigerator along pipe 34, reducing the cooling effect on the valve of escaping cryogen gas, as the escaping cryogen gas will have warmed to some extent by the time it reaches the valve and the temperature at which the valve closes could be raised.

The present invention accordingly has a passive temperature-sensitive valve 30 that is activated by the temperature of cryogen gas passing through the refrigerator sock, operating to stop gas flow through the refrigerator sock thereby preventing overcooling of the refrigerator and consequent damage or failure of the refrigerator.

The passive temperature-sensitive valve 30 may itself be embodied in any of a number of known types of passive temperature-sensitive valve.

For example, the temperature sensitive valve may include a bi-metallic element; or a substance that expands with temperature, such as a wax; or a gas that boils or expands housed in a bellows or diaphragm.

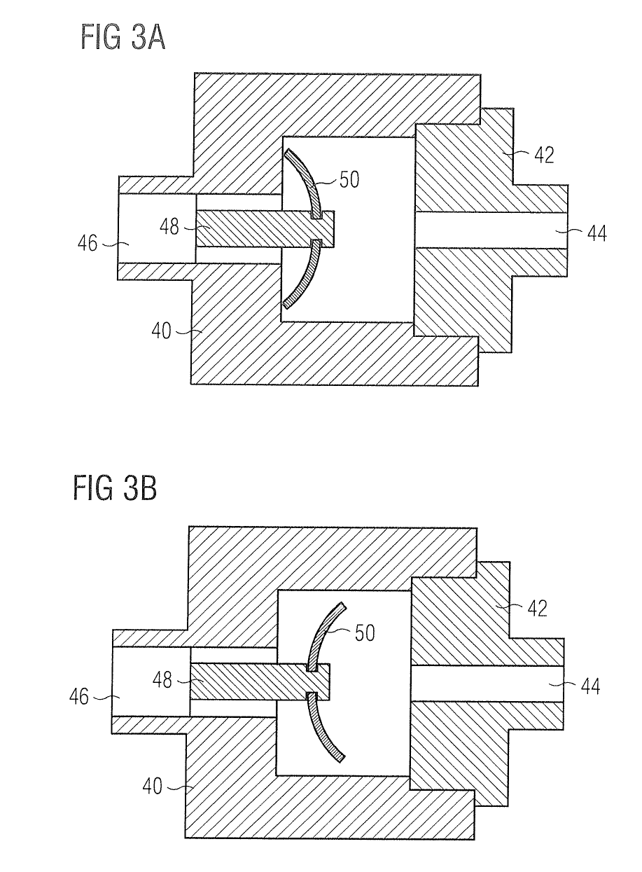

FIGS. 3A-3B represent a valve using a bi-metallic ‘snap disc’ commonly used in thermostats. This type of valve has a dished bi-metallic disc 50 that reverses its direction of dish at a predetermined temperature.

The valve of FIGS. 3A-3B has a housing 40 with a closure 42, having an inlet 44 and an outlet 46. A mounting post 48 retains dished bi-metallic disc 50 in position, adjacent to the outlet 46. FIG. 3A shows the valve in its “closed” status, as it would be at temperatures below about 0° C. in the described example. Outlet 46 is substantially blocked by the dished bi-metallic disc. By suitable positioning within the valve housing, such dished bi-metallic disc may operate to seal the inlet 44 or the outlet 46. If arranged with the flow direction as shown in FIGS. 3A-3B, differential pressure across the valve, particularly significant in case of a quench, will help close the valve, and to maintain it in the closed position.

FIG. 3B shows the valve of FIG. 3A in its “open” status, as it would be at temperatures above about 15° C. in the described example. The direction of dishing (curvature) of the dished bi-metallic disc 50 is reversed, allowing gas flow through the outlet 46.

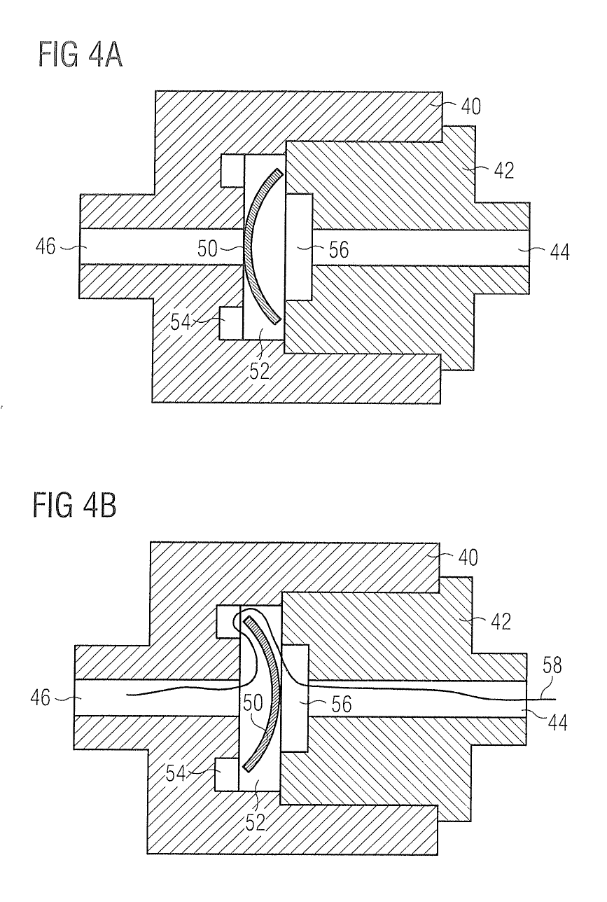

FIGS. 4A-4B illustrate operation of an alternative temperature-sensitive valve.

Parts corresponding to features shown in FIGS. 3A-3B carry corresponding reference numerals. In this valve, dished bi-metallic disc 50 is not retained in position as in FIGS. 3A-3B, but instead is enclosed within a cavity 52. Housing 40 provides recesses 54 opening into the cavity 52, as will be explained below. Closure 42 also provides a cavity 56 that opens into cavity 52.

In the status illustrated in FIG. 4A, the valve is in its “closed” position, as it would be in the described example when cooled to about 0° C. or below. The direction of dishing causes the dished bi-metallic disc 50 to block the outlet 46. The direction of cryogen flow, from inlet 44 to outlet 46, maintains the bi-metallic disc 50 in position, blocking the outlet 46.

FIG. 4B shows the valve in its other state, its “open” position such as the valve of the described embodiment would be at temperatures of about 15° C. and above. The direction of dish of the bi-metallic disc 50 is reversed. The bi-metallic disc 50 is retained within cavity 52, but recesses 54 and 56 provide a flow path for cryogen, around the periphery of the bi-metallic disc 50. The direction of cryogen flow, from inlet 44 to outlet 46, tends to maintain the bi-metallic disc 50 in position, keeping the flow path 58 open.

In the described example, the dished bi-metallic disc changes status on cooling to about 0° C. and on warming to about 15° C. This prototype valve was attached to a conventional superconducting magnet for an MRI system in an arrangement corresponding to FIG. 2. The temperature-sensitive valve was arranged to vent to atmosphere rather than via a vent valve for an initial test.

In operation, it was found that once the bi-metallic disc 50 had reversed dishing on cooling, virtually all cryogen gas flow was stopped. The temperature at which the disc reverses dishing is affected by its distance from the refrigerator and the direction of flow of the cryogen gas. The refrigerator was found not to cool significantly even in case of quench of the magnet in the cryogen vessel.

While the present invention has been explained with reference to certain particular types of valve, and certain particular temperature ranges, the present invention may be embodied with other passive temperature-sensitive valve types and at other temperature ranges, as suitable for the application and the type of cryogen used. Also other pipe interconnection arrangements could be possible. While the described embodiments include a conventional valve 23 enabling a conventional path for circulation of a cryogen gas, some embodiments of the present invention may not include the conventional valve and the associated cryogen path, but may include only the path 34 controlled by the temperature sensitive valve 30. In such embodiments, enabling valve 32 may be unnecessary.

Although modifications and changes may be suggested by those skilled in the art, it is the intention of the Applicant to embody within the patent warranted hereon all changes and modifications as reasonably and properly come within the scope of the Applicant's contribution to the art.

1. A cryostat comprising:
a cryogen vessel;
a refrigerator sock;
a cryogenic refrigerator that cools an interior of the cryogen vessel, said cryogenic refrigerator being inside said refrigerator sock;
a pipe controlled by a passive temperature-sensitive valve in order to selectively provide a path for cryogen gas flow through the refrigerator sock; and
said passive temperature-sensitive valve having a valve body and being controlled according to a temperature of said valve body.

2. A cryostat according to claim 1 wherein the temperature sensitive valve is controlled so as to be in a closed status at temperatures of said valve body below about 0° C.

3. A cryostat according to claim 1 wherein the temperature sensitive valve is controlled so as to be in an open status at temperatures of said valve body above 15° C.

4. A cryostat according to claim 1 wherein the path extends from the refrigerator sock to the cryogen vessel.

5. A cryostat according to claim 1 wherein said path is a first path, and further comprising a further pipe controlled by a further valve to selectively provide a second path for cryogen gas flow through the refrigerator sock, in parallel with the first path.

6. A cryostat according to claim 5 wherein the second path extends from the refrigerator sock to the cryogen vessel.

7. A cryostat according to claim 1, further comprising a vent valve arranged to vent cryogen from the cryogen vessel in case of excess cryogen gas pressure within the cryogen vessel.

8. A cryostat according to claim 1, wherein the passive temperature-sensitive valve comprises a bi-metallic element.

9. A cryostat according to claim 6 wherein the bi-metallic element is a dished bi-metallic disc.

10. A cryostat according to claim 1, wherein the temperature-sensitive valve comprises a wax that expands with temperature.

11. A cryostat according to claim 1, wherein the temperature-sensitive valve comprises a fluid that boils or expands, housed in a bellows or diaphragm.

12. A cryostat according to claim 1, wherein the temperature of the valve body of the valve is determined by a combination of:
a temperature of the cryogen gas supplied from the refrigerator sock to the temperature-sensitive valve;
ambient temperature; and
a temperature of equipment to which the valve body is mounted.
